(19) United States
(12) Patent Application Publication
(10) Pub. No.: US 2012/0193412 A1
(43) Pub. Date: Aug. 2, 2012

(54) REVERSIBLE BANKNOTE CONVEYING CHANNEL DEVICE

(75) Inventors: Baisong Chen, Guangzhou (CN); Zhiyong Liu, Guangzhou (CN)

(73) Assignee: GRG BANKING EQUIPMENT CO., LTD., Guangzhou, Guangdong (CN)

(21) Appl. No.: 13/500,281

(22) PCT Filed: Sep. 21, 2010
(86) PCT No.: PCT/CN10/77200

§ 371 Date: Apr. 4, 2012

(30) Foreign Application Priority Data
Oct. 20, 2009 (CN) 200910193185.1

(51) Int. Cl. G07D 11/00

(52) U.S. Cl. 235/379

(57) ABSTRACT

A banknote conveying channel device, especially a multi-path steering banknote conveying channel device is provided. The device is arranged between an upper machine mechanism which has the functions of banknote recognition and note sorting and a lower machine mechanism for storing banknote, and is used for transmitting and separating paper money in a reversing way. The device comprises a bracket, a pair of transmission belts (0211, 0212), a first channel plate (0221), a second channel plate (0222), a third channel plate (0223) and a reversing mechanism (023). The reversing mechanism (023) comprises a reversing axis and multiple reversing blocks arranged in parallel with certain interval between each other, in which the reversing axis is socketed, and a electromagnetic valve, which controls the reversing blocks switch between a first position and a second position. The reversing block has a shape of “<”, and comprises two terminals and a inside concaved interface between the two terminals. A convex edge, which substantially accords with the inside concaved interface in radian, is installed on the inside concaved interface.

The present application claims the benefit of priority to Chinese patent application No. 200910193185.1 titled “REVERSIBLE BANKNOTE CONVEYING CHANNEL DEVICE”, filed with the Chinese State Intellectual Property Office on Oct. 20, 2009. The entire disclosures thereof are incorporated herein by reference.

### FIELD OF THE INVENTION

The present invention relates to a paper money transporting device, and more particularly, to a paper money transporting passage device having multiple diverting paths.

### BACKGROUND OF THE INVENTION

Existing financial self-service terminal includes the cash deposit machine, the automatic teller machine and the automatic depositing and withdrawing machine. In these machines which may directly deal with paper currency, in order to achieve the exchange of paper money between the user and the machine, it is necessary to install a paper money transporting passage device in these machines. The device is used to transport paper money to be deposited into the self-service instrument by user to the terminal cashbox and/or transport paper money in the terminal cashbox to the user.

However, the automatic teller system in financial self-service instruments generally has a plurality of banknote receiving rooms, and thus a diverting mechanism for changing the transporting path of paper money is required. Diverting pieces and a passage plate of the conventional diverting mechanism are staggered in a teeth-shaped manner. It is inevitable that a gap between teeth of the diverting pieces at the diverting turning position just is a right-angle turning feature of the passage plate. When any of corners of an inclined paper money in the passage faces the above gap, the corner of paper money is prone to insert into the gap, and result in the folded edge and wrinkle, even jamming to block the passage, which have to be handled manually. Therefore, the stability and reliability of the device are decreased, and the maintenance cost of the device is increased.

### SUMMARY OF THE INVENTION

The object of the invention is to provide a divertable paper money transporting passage device, which allows paper money to enter into a plurality of receiving rooms respectively, and may avoid the jamming of inclined paper money at the diverting turning position.

A paper money transporting passage device is disposed between an upper machine mechanism for discriminating and distributing paper money and a lower machine mechanism for storing paper money, and is configured to divert, transport and separate paper money. The paper money transporting passage device includes a bracket configured to install the paper money transporting passage; a pair of transmission belts wound around driving shafts and configured to delivery paper money; a first passage plate disposed on the bracket; a second passage plate installed on the bracket and forming a first paper money transporting path with the first passage plate; a third passage plate installed on the bracket and arranged side by side with the second passage plate and forming a second paper money transporting path with the first passage plate, wherein a paper money inlet/outlet of the first paper money transporting path is formed between the third passage plate and the second passage plate; and a diverting mechanism provided between the third passage plate and the second passage plate and configured to selectively open or close the paper money inlet/outlet of the first paper money transporting path. The diverting mechanism includes a diverting shaft, a plurality of diverting pieces mounted side by side on the diverting shaft with a certain distance therebetween, and a solenoid valve for controlling the switching of the diverting pieces between a first position and a second position. Each diverting piece is of a “<” shape and has two ends and an inner concave surface between the two ends. A rib is provided on the inner concave surface and has an approximately same curvature as the inner concave surface.

Preferably, the paper money transporting passage device further includes a fourth passage plate arranged side by side with the third passage plate and forming a third paper money transporting path with the first passage plate. A paper money inlet/outlet of the second paper money transporting path is formed between the fourth passage plate and the third passage plate. Another same diverting mechanism is provided between the fourth passage plate and the third passage plate and configured to selectively open or close the paper money inlet/outlet of the second paper money transporting path.

Compared with the prior art, the paper money transporting passage device according to the present invention has the following advantages.

The paper money transporting passage device according to the present invention has the diverting mechanism, such that paper money may enter into a plurality of receiving rooms. The diverting pieces of the diverting mechanism are of the “<” shape, and the ribs are provided on the inner concave surfaces and have an approximately same curvature as the inner concave surfaces. When the diverting pieces are located at the first position, the paper money inlet/outlet of the first paper money transporting path is opened by the diverting mechanism. At this moment, two ends of each diverting piece are staggered with the teeth-shaped bodies of the first passage plate and the third passage plate, respectively. The ribs project outward the staggered interface between the diverting pieces and the teeth-shaped bodies on the passage plates, and inclined paper money is curled and raised in a turning direction so as to smoothly pass through the turning position, thereby preventing paper money from jamming at the diverting turning position.

### BRIEF DESCRIPTION OF THE DRAWINGS

FIG. 1 is a general schematic view of the machine mechanism of the automatic depositing and withdrawing machine;

FIG. 2 is a partial schematic side view of a paper money transporting passage device according to a preferred embodiment of the present invention;

FIG. 3 is a structural view of the transmission belt in FIG. 2;

FIG. 4 is a partial enlarged view of FIG. 2, showing the position relationship between the diverting mechanism and the passage plate;

FIG. 5 is a perspective view of the diverting mechanism;

FIG. 6 is a perspective side view of the diverting pieces of the diverting mechanism located at the first position and the second position respectively;

FIG. 7 is a schematic perspective view of the passage plate, showing the teeth-shaped bodies thereof which may be engaged with the diverting mechanism;

FIG. 8 is a schematic view showing that the diverting pieces obstruct the paper money inlet/outlet A1 between the second and third passage plates when the diverting pieces are located at the second position;

FIG. 9 is a partial schematic side view of the paper money transporting passage when the diverting pieces are located at the first position;

FIG. 10 is a schematic perspective view showing that the diverting pieces are staggered with the first and third passage plates in the teeth-shaped manner when the diverting pieces are located at the first position;

FIG. 11 is a partial schematic view of the paper money transporting device when the paper money is turned, mainly showing that the ribs on the diverting pieces are raising paper money; and

FIG. 12 is a schematic view showing that paper money is further turned.

### DETAILED DESCRIPTION

Hereinafter, the technical solutions in embodiments of the present invention will be described clearly and completely with reference to drawings of the embodiments of the present invention. It is apparent that the embodiments to be described are merely a portion of embodiments of the present invention, but not all of the embodiments. Based on the embodiments of the present invention, all of other embodiments made by those skilled in the art without inventive effort fall into the protection scope of the present invention.

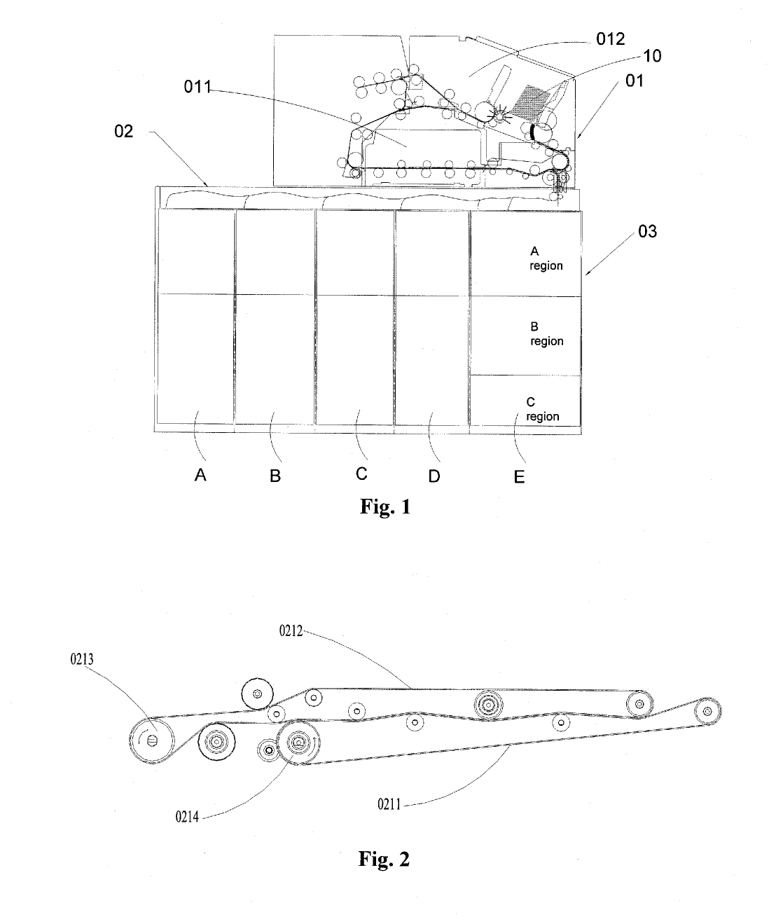

Referring to FIG. 1, a general schematic view of the machine mechanism of the automatic depositing and withdrawing machine is shown. The machine mechanism includes an upper machine mechanism 01 having a paper money discriminating module 011 and a separating module 012, a paper money transporting passage 02 and a lower machine mechanism 03 having a plurality of cashboxs. When paper money 10 is deposited to the automatic depositing and withdrawing machine, paper money 10 passes through the paper money discriminating module 011 one by one after being separated by the separating module. Paper money which is allowed to be deposited passes through a vertical machine mechanism connector passage into the horizontal paper money transporting passage 02, and then is transported into a corresponding storage cashbox by the paper money transporting passage 02 according to a command from a control centre (not shown).

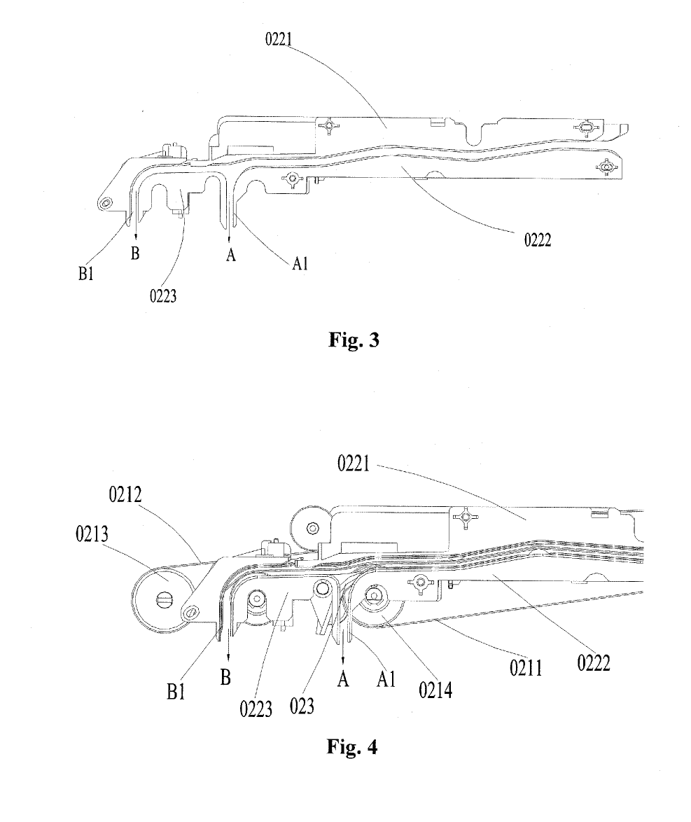

Referring to FIG. 2, a partial schematic side view of a preferred paper money transporting passage device according to the present invention is shown. The paper money transporting passage device includes a bracket (not shown) configured to install the paper money transporting passage, transmission belts 0211 and 0212 respectively wound around drive shafts 0213 and 0214 and configured to delivery paper money (also referring to FIG. 3), a first passage plate 0221 disposed on the bracket, a second passage plate 0222 installed on the bracket and forming a first paper money transporting path A with the first passage plate, and a third passage plate 0223 installed on the bracket, arranged side by side with the second passage plate 0222 and forming a second paper money transporting path B with the first passage plate 0221. A paper money inlet/outlet A1 is formed between the third passage plate 0223 and the second passage plate 0222.

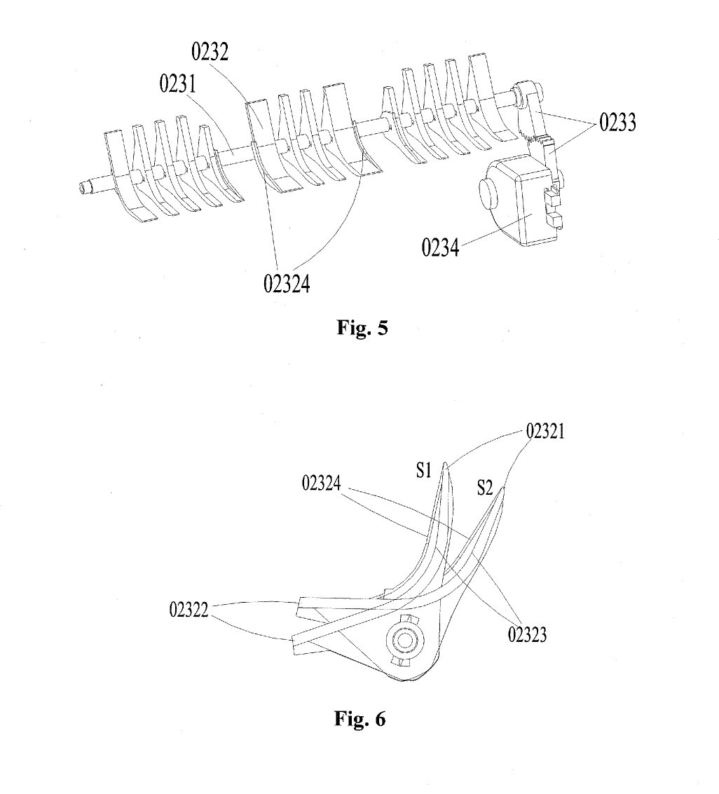

As shown in FIG. 4, the paper money transporting passage further includes a diverting mechanism 023 provided between the third passage plate 0223 and the second passage plate 0222. The diverting mechanism 023 may selectively opens or closes the paper money inlet/outlet A1 of the first paper money transporting path A. As shown in FIG. 5, the diverting mechanism 023 includes a diverting shaft 0231, a plurality of diverting pieces 0232 mounted side by side on the diverting shaft 0231 with a certain distance therebetween, and a solenoid valve 0234 controlling the switching of diverting pieces between a first position and a second position. Certainly, transmission gears 0233 are provided between the solenoid valve 0234 and the diverting shaft 0231. The transmission gears 0233 transfer the power of the solenoid valve to the diverting shaft 0231, such that the diverting shaft 0231 may be rotated by a certain degree of angle and thus the diverting pieces 0232 mounted thereon may be rotated by a certain degree of angle, thereby switching between the first position S1 and the second position S2, as shown in FIG. 6. In addition, as shown in FIG. 6, each diverting piece is of a “<” shape, which includes two ends 02321, 02322 and an inner concave surface 02323 between the two ends. A rib 02324 is provided on the inner concave surface 02323 and has an approximately same curvature as the inner concave surface.

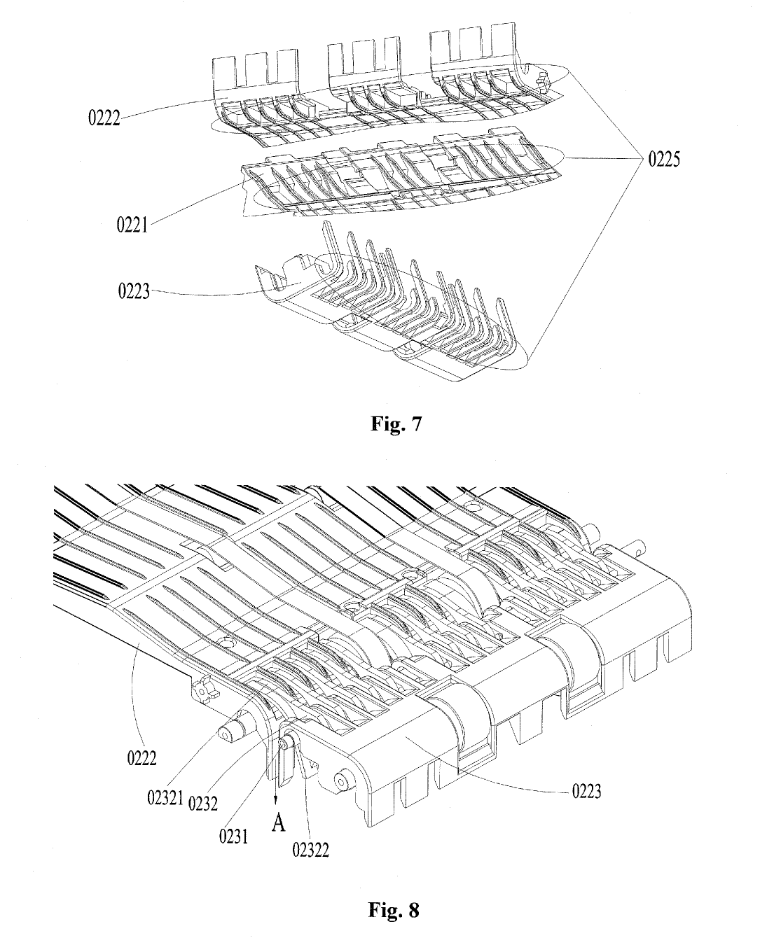

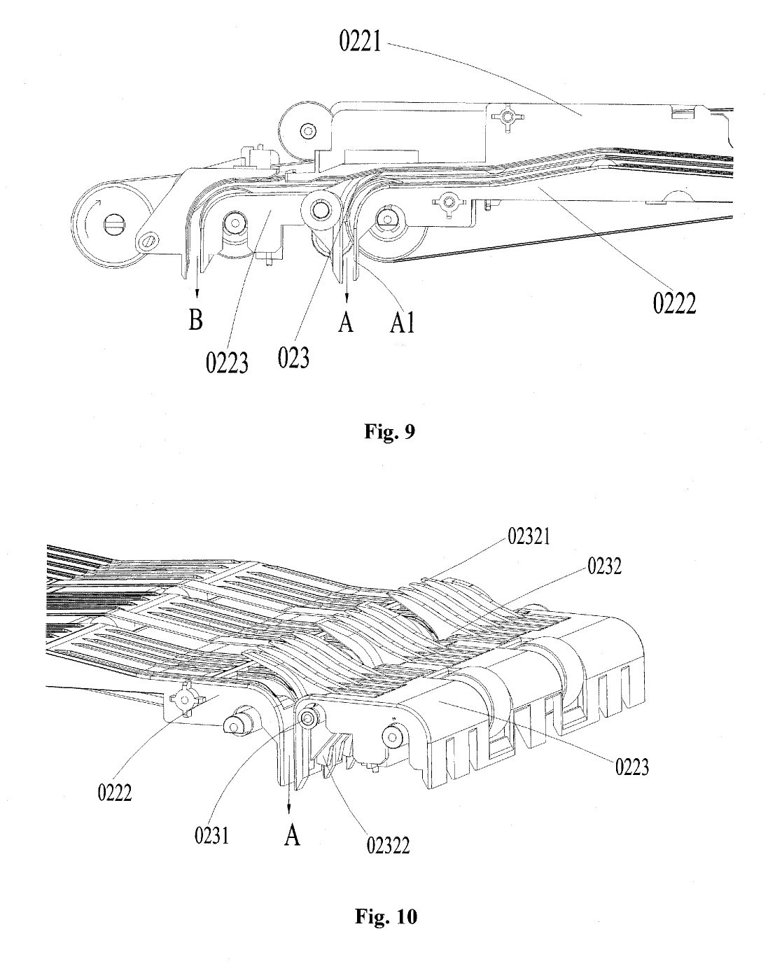

Referring to FIG. 7, teeth-shaped bodies 0225 are provided on surfaces of the passage plates 0221, 0222, 0223 adjacent to the positions where the diverting mechanism 023 is installed. The diverting pieces 0232 and the passage plate 0221, 0222 or 0223 are staggered in a teeth-shaped manner when they are engaged. As shown in FIG. 8, when the diverting pieces 0232 are located at the second position S1, one end 02321 of the diverting pieces 0232 and the passage plate 0222 are staggered in a teeth-shaped manner, and the other end 02322 and the passage plate 0223 are staggered in a teeth-shaped and non-coplanar manner, thereby obstructing the paper money inlet/outlet A1 of the first paper money transporting path A between the second passage plate 0222 and the third passage plate 0223. In this way, paper money are continuously transported in the passage so as to be transported to the other paper money inlet/outlet in the passage. As shown in FIGS. 9 and 10, when the diverting pieces 0232 are located at the first position S2, one end 02321 of the diverting pieces 0232 and the passage plate 0221 are staggered in a teeth-shaped manner, and the other end 02322 and the passage plate 0223 are staggered in a teeth-shaped and coplanar manner. At this moment, the diverting pieces 0232 obstructs the paper money transporting passage formed between the first passage plate 0221 and the third passage plate 0223, such that paper money cannot be transported in the transporting passage and the transporting direction of paper money is changed at the diverting structure. At the same time, the paper money inlet/outlet A1 of the first paper money transporting path A between the second passage plate 0222 and the third passage plate 0223 is in an open state. Therefore, paper money will be transported and pass through the paper money inlet/outlet A1 along the first paper money transporting path A. Thus, if desired, paper money may pass through the paper money inlet/outlet A1 or B1 by the actuation of the diverting mechanism 023, such that paper money may enter into a plurality of receiving rooms.

Of cause, a plurality of passage plates may be provided, in order to form a plurality of paper money transporting paths. The diverting mechanism may be provided at the paper money inlet/outlet of each paper money transporting path, such that paper money may selectively enter a plurality of receiving rooms.

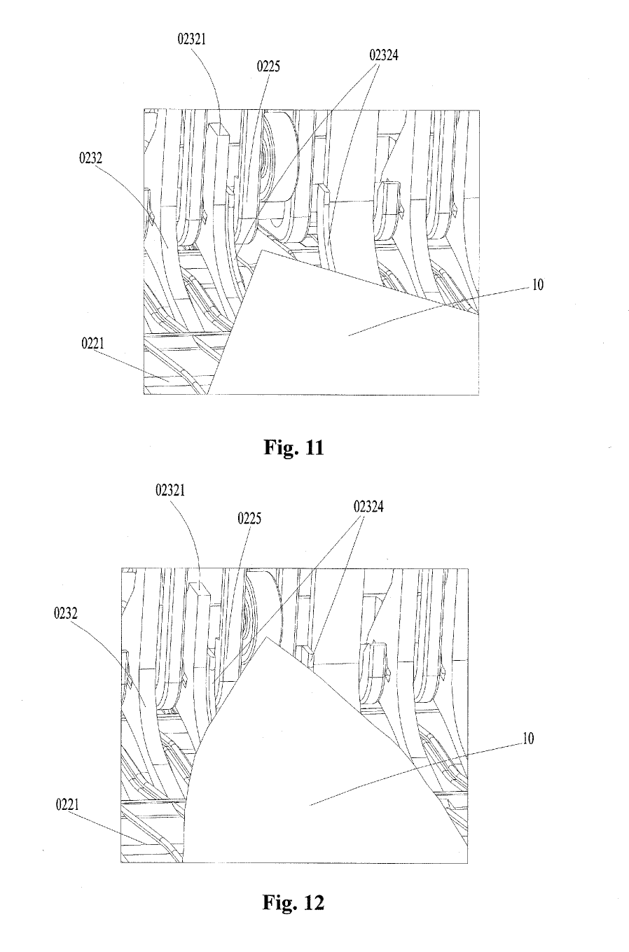

As shown in FIGS. 11 and 12, when the diverting pieces 0232 are located at the first position S2, the ribs 02324 on the diverting pieces 0232 project outward the staggered interface between the diverting pieces 0232 and the teeth-shaped bodies 0225 on the passage plate 0223, and inclined paper money is curled and raised in the turning direction so as to smoothly pass through the turning position, thereby preventing paper money from jamming at the diverting turning position. In addition, the ribs 02324 may also fill up the gaps between the teeth-shaped bodies 0225 on the passage plate 0223, such that the teeth-shaped staggered interface between the diverting piece 0232 and the passage plate 0223 becomes smoother at the turning position, which helps to further prevent paper money from inserting any gaps at the turning position. Therefore, the jamming of paper money may be avoided.

While the preferred embodiments of the present invention have been described above, it is not intended to limit the protection scope of the present invention. Therefore, various equivalent variations made by those skilled in the art based on the contents described in the Description and illustrated in drawings of the present invention are deemed to fall into the protection scope of the present invention.

What is claimed is:

1. A paper money transporting passage device disposed between an upper machine mechanism for discriminating and distributing paper money and a lower machine mechanism for storing paper money, wherein the paper money transporting passage device is configured to divert, transport and separate paper money and comprises:
a bracket configured to install the paper money transporting passage;
a pair of transmission belts wound around driving shafts and configured to delivery paper money;
a first passage plate disposed on the bracket;
a second passage plate installed on the bracket and forming a first paper money transporting path with the first passage plate;
a third passage plate installed on the bracket, arranged side by side with the second passage plate and forming a second paper money transporting path with the first passage plate, wherein a paper money inlet/outlet of the first paper money transporting path is formed between the third passage plate and the second passage plate; and
a diverting mechanism provided between the third passage plate and the second passage plate and configured to selectively open or close the paper money inlet/outlet of the first paper money transporting path,
characterized in that the diverting mechanism comprises a diverting shaft, a plurality of diverting pieces mounted side by side on the diverting shaft with a certain distance therebetween, and a solenoid valve for controlling the switching of the diverting pieces between a first position and a second position, and wherein each diverting piece is of a “<” shape and comprises two ends and an inner concave surface between the two ends, and a rib is provided on the inner concave surface and has an approximately same curvature as the inner concave surface.

2. The paper money transporting passage device according to claim 1, wherein the paper money transporting passage device further comprises a fourth passage plate arranged side by side with the third passage plate and forming a third paper money transporting path with the first passage plate, a paper money inlet/outlet of the second paper money transporting path is formed between the fourth passage plate and the third passage plate, another same diverting mechanism is provided between the fourth passage plate and the third passage plate and configured to selectively open or close the paper money inlet/outlet of the second paper money transporting path.

3. The paper money transporting passage device according to claim 1, wherein the solenoid valve is a rotary electromagnet.

4. The paper money transporting passage device according to claim 1, wherein the solenoid valve is a linear electromagnet, the linear electromagnet, cooperating with a spring, provides power for the diverting pieces.
